(19) United States
(12) Patent Application Publication
(10) Pub. No.: US 2026/0163622 A1
(43) Pub. Date: Jun. 11, 2026

(54) METHOD AND APPARATUS FOR DETECTING BEAM DIRECTION BASED ON HYBRID RIS IN WIRELESS COMMUNICATION SYSTEM

(71) Applicant: ELECTRONICS AND TELECOMMUNICATIONS RESEARCH INSTITUTE, Daejeon (KR)

(72) Inventors: Seon-Ae Kim, Daejeon (KR); Hee Sang Chung, Daejeon (KR)

(21) Appl. No.: 19/410,971

(22) Filed: Dec. 5, 2025

(30) Foreign Application Priority Data
Dec. 5, 2024 (KR) 10-2024-0179171
Jun. 19, 2025 (KR) 10-2025-0080758

(51) Int. Cl. H04B 7/06; H04B 7/04; H04L 5/00; H04W 56/00

(52) U.S. Cl. CPC H04B 7/0617; H04B 7/04013; H04L 5/0051; H04W 56/0015

(57) ABSTRACT

Disclosed is a method of finding a beam direction by using a hybrid RIS in a wireless communication system. The method that is performed in an RIS apparatus includes receiving a control signal related to synchronization acquisition and a beam direction finding-reference signal (BDF-RS) that is used to measure a reception beam direction from a transmission apparatus, decoding the BDF-RS by obtaining synchronization based on the control signal, generating a beam direction finding indicator (BDFI) related to the acquisition of line-of-sight (LOS) direction information of a transmission beam of the transmission apparatus based on the decoded BDF-RS, and reporting a beam measurement result including the BDFI and index information of the control signal to the transmission apparatus.

### CROSS-REFERENCE TO RELATED APPLICATIONS

This application claims the benefit of Korean Patent Application Nos. 10-2024-0179171 filed on Dec. 5, 2024, and 10-2025-0080758 filed on Jun. 19, 2025, which are hereby incorporated by reference as if fully set forth herein.

### BACKGROUND

### 1. Technical Field

This specification relates to a method of finding and managing a beam based on a hybrid reconfigurable intelligent surface (RIS) in a wireless communication system.

### 2. Related Art

A reconfigurable intelligent surface (RIS) is considered as a core candidate technique in 5G-Advanced and 6G communication systems in that the RIS improves spectrum efficiency at a low cost and can expand communication coverage and cover a shadow area by artificially reconfiguring a radio propagation environment through the programming of a cell-based meta surface including a reconfigurable element. In particular, in 5G and 6G communication, in order to use a frequency of a millimeter wave or more so that a large amount of information can be transmitted based on a wide band, coverage expansion techniques for overcoming the deterioration of signal quality attributable to signal attenuation and a radio wave blocking problem attributable to a surrounding radio wave obstacle become very important.

In general, the RIS may be divided into a passive RIS that includes a passive element depending on a method of adjusting the phase and amplitude of a meta surface and that uses a method of adjusting and reflecting only the phase of an incident signal and an active RIS that includes a passive element and an active element, such as an amplifier, and that reflects an incident signal by adjusting the phase and amplitude of a meta surface. The passive RIS includes a passive element and has advantages of low power consumption and relatively low installation costs, but has limitations in finely adjusting the phase of a reflected signal. The active RIS has good performance because the phase and size of a reflected signal can be adjusted by adjusting both the phase and amplitude of a meta surface, but has disadvantages in that power consumption within an active element is high and the complexity of a meta surface configuration is increased. A semi-passive RIS, that is, an intermediate stage of the passive RIS and the active RIS, can configure a finer reflection phase compared to the passive RIS by limitedly using a small amount of power because the active element is disposed in a specific area, and can improve the quality of a reflected signal or reflection beam performance. Furthermore, the semi-passive RIS enables the design of a hybrid type RIS including functions, such as simple signal processing and timing synchronization estimation, because a transceiver apparatus is configured in some meta surface.

In a mobile communication system, the main purpose of an RIS is to improve the quality of a received signal by steering an incident signal in the direction of a receiver through an optimal reflection beam or to improve communication performance of the entire network by reducing inter-multi-beam interference attributable to multiple transmission and reception points of the network. In general, in the RIS, the phase coefficient of a reflection surface must be optimized based on a movement of a receiver and a channel state in order to improve communication performance because an incident signal is simply reflected based on a phase rotation component of a coefficient set in the meta surface. A method of finding an RIS pattern having an optimal value by measuring signal quality for an inter-end link while adjusting the values of N reflection elements is used as a method of finding an optimal RIS reflection phase coefficient. In this case, a method of finding all of RIS reflection elements for an optimal value causes too great time latency in an RIS beam configuration and greatly increases the complexity of control signaling for channel estimation and beam search. It is difficult to apply an RIS optimal-value estimation method that requires a high signal processing cost as described above to actual communication. Accordingly, a method of pre-defining a codebook including a set of specific phase values for several candidate beams in the RIS and setting an RIS reflection phase value corresponding to the configured codebook in response to a control signal through the interface of a network and an RIS control circuit (hereinafter referred to as an “RIS controller”) is used as a method of configuring an RIS reflection beam in a communication system based on the passive RIS. However, the method of configuring a reflection beam through the codebook has limitations in the beam width and reflection angle of an RIS reflection beam because the number of codebooks is limited. Furthermore, as the reflection beam is finely configured, time latency essentially occurs in a process of finding an optimal reflection beam because the number of codebooks is increased.

A hybrid RIS has an advantage in that channel estimation, that reflection phase optimization is, performance, can be improved because a channel is divided into channels for transmission apparatus-RIS and RIS-reception apparatus and the divided channels are estimated, instead of a method of performing channel estimation between two ends by configuring a transceiver in a specific area and receiving a pilot signal in the RIS or transmitting a pilot signal in the RIS as in a semi-passive RIS apparatus. However, power consumption in the RIS is limited, and a low-cost hardware design needs to be considered. Accordingly, the hybrid RIS has a disadvantage in that channel estimation performance is low because channel estimation is performed by using signals received through very small active areas. Accordingly, there is a need for an effective RIS phase optimization method in a reflection element K (hereinafter referred to as an “activation reflection element/activated element”) having a very smaller transceiver function than all of reflection elements N.

### SUMMARY

Accordingly, this specification provides a method and apparatus for detecting a beam direction with relatively high accuracy while achieving a relatively simple RIS receiver configuration and limited power consumption in a wireless communication system based on a hybrid RIS in order to solve the channel estimation complexity and time latency problem of a wireless communication system based on a passive RIS.

Technical objects to be achieved by the present disclosure are not limited to the aforementioned object, and the other objects not described above may be evidently understood from the following description by a person having ordinary knowledge in the art to which the present disclosure pertains.

In this specification, in a method of finding a beam direction by using a hybrid reconfigurable intelligent surface (RIS) in a wireless communication system, the method performed in an RIS apparatus includes receiving a control signal related to synchronization acquisition and a beam direction finding-reference signal (BDF-RS) that is used to measure a reception beam direction from a transmission apparatus, decoding the BDF-RS by obtaining synchronization based on the control signal, generating a beam direction finding indicator (BDFI) related to the acquisition of line-of-sight (LOS) direction information of a transmission beam of the transmission apparatus based on the decoded BDF-RS, and reporting a beam measurement result including the BDFI and index information of the control signal to the transmission apparatus.

Furthermore, in this specification, the control signal is a synchronization signal block (SSB) or a sounding reference signal (SRS).

Furthermore, in this specification, the method further includes comparing the BDFI with a threshold that is preset to limit the transmission beam to a LOS direction beam.

Furthermore, in this specification, the BDFI included in the beam measurement result is a BDFI having a value equal to or greater than the threshold.

Furthermore, in this specification, the BDF-RS is transmitted in at least one of a PBCH resource region of the SSB or a demodulation reference signal (DMRS) resource region for PBCH transmission.

Furthermore, in this specification, the sequence of the BDF-RS is generated by multiplying the sequence of the DMRS by a value of a precoding weight including a vector set of a plurality of antennas.

Furthermore, in this specification, the value of the precoding weight includes two values of beams each having a center shifted left and right at an identical angle centering around the LOS direction.

Furthermore, in this specification, a different weight value is applied to the sequence of the DMRS for each subcarrier group.

Furthermore, in this specification, the BDF-RS is allocated to at least one symbol at which the PBCH is allocated to the SSB or allocated to an upper band and lower band of a frequency band to which a secondary synchronization signal (SSS) of the SSB is allocated.

Furthermore, in this specification, the BDFI is generated as an internal value of a vector for the sequence of the DMRS for PBCH transmission and a vector for the sequence of the BDF-RS.

Furthermore, in this specification, the RIS apparatus receives the control signal and the BDF-RS in a reception mode.

Furthermore, in this specification, the method further includes receiving instruction information that instructs the RIS apparatus to switch from the reception mode to a reflection mode from the transmission apparatus and switching, by the RIS apparatus, from the reception mode to the reflection mode based on the instruction information.

Furthermore, in this specification, in a method of finding a beam direction by using a hybrid reconfigurable intelligent surface (RIS) in a wireless communication system, the method performed in a transmission apparatus includes generating a beam direction finding-reference signal (BDF-RS) that is used to measure a reception beam direction of an RIS apparatus, transmitting the BDF-RS to the RIS apparatus along with a control signal related to synchronization acquisition, receiving a beam measurement result including a beam direction finding indicator (BDFI) related to the acquisition of line-of-sight (LOS) direction information of a transmission beam of the transmission apparatus and index information of the control signal from the RIS apparatus, and determining a transmission beam direction of the transmission apparatus based on the beam measurement result.

Furthermore, in this specification, a reconfigurable intelligent surface (RIS) apparatus for finding a beam direction by using a hybrid RIS in a wireless communication system includes an RF processing module configured to convert n RF signal received through an antenna into a baseband signal, a baseband processing module configured to decode a beam direction finding-reference signal (BDF-RS) by obtaining timing synchronization based on a control signal related to synchronization acquisition and configured to generate a beam direction finding indicator (BDFI) related to the acquisition of line-of-sight (LOS) direction information of a transmission beam of a transmission apparatus based on the BDF-RS, and an RIS processor configured to manage the BDFI and index information of the control signal by mapping the BDFI and the index information and configured to compare the BDFI with a threshold that is preset to limit the transmission beam to a LOS direction beam.

This specification has effects in that the limitations of the hybrid RIS can be overcome and multi-beam management and RIS optimal beam search can be efficiently performed through the detection of a beam direction having relatively high accuracy while achieving a relatively simple RIS receiver configuration and limited power consumption in a wireless communication system based on a hybrid RIS.

Furthermore, in this specification, an RIS reflection coefficient can be set in a slot unit or a symbol unit because timing synchronization can be provided to the RIS controller through the hybrid RIS configuration. Accordingly, the rapid optimization of the RIS reflection coefficient becomes possible, enabling a fast response to communication-interruption situations, because the beam-management control signal and control procedure can be flexibly configured at a symbol unit time resolution.

Effects of the present disclosure which may be obtained in the present disclosure are not limited to the aforementioned effects, and the other effects not described above may be evidently understood by a person having ordinary knowledge in the art to which the present disclosure pertains from the following description.

### BRIEF DESCRIPTION OF THE DRAWINGS

The accompanying drawings, which are included as part of the detailed description in order to help understanding of the present disclosure, provide embodiments of the present disclosure and describe the technical characteristics of the present disclosure along with the detailed description.

FIG. 1 illustrates an example of a concept view of an RIS support wireless communication system to which a method proposed in this specification may be applied.

FIG. 2 is a diagram illustrating an example of a method of transmitting a beam direction finding-reference signal (BDF-RS) by using an SSB in a wireless communication system based on a hybrid RIS, which is proposed in this specification.

FIG. 3 illustrates an example of a method of transmitting a BDF-RS by using an SRS in a wireless communication system based on a hybrid RIS, which is proposed in this specification.

FIG. 4 illustrates an example of an internal block diagram of an RIS receiver that is proposed in this specification.

FIG. 5 is a diagram illustrating examples of a method of transmitting a BDF-RS, which is proposed in this specification.

FIG. 6 is a flowchart illustrating an example of a method of finding a beam direction, which is proposed in this specification.

FIG. 7 is a flowchart illustrating an example of a method of finding a beam direction by using a hybrid RIS in a wireless communication system, which is proposed in this specification.

FIG. 8 is a flowchart illustrating another example of a method of finding a beam direction by using a hybrid RIS in a wireless communication system, which is proposed in this specification.

### DETAILED DESCRIPTION

It is to be noted that technological terms used in this specification are used to describe only specific embodiments and are not intended to limit this specification. Furthermore, the technological terms used in this specification should be construed as having meanings that are commonly understood by those skilled in the art to which this specification pertains unless especially defined as different meanings otherwise in this specification, and should not be construed as having excessively comprehensive meanings or excessively reduced meanings. Furthermore, if the technological term used in this specification is a wrong technological term that does not precisely represent the spirit of a technology disclosed in this specification, the technological term should be replaced with a technological term which may be correctly understood by a person having ordinary knowledge in the field disclosed in this specification and understood. Furthermore, common terms used in this specification should be interpreted in accordance with the definition of dictionaries or in accordance with the context, and should not be construed as having excessively reduced meanings.

Furthermore, terms including ordinal numbers, such as a “first” and a “second”, which are used in this specification, may be used to describe various components, but the components are not restricted by the terms. The terms are used to only distinguish one component from the other components. For example, a first component may be named a second component without departing from the scope of rights of this specification. Likewise, the second component may be named the first component.

Hereinafter, embodiments according to this specification are described in detail with reference to the accompanying drawings. The same or similar component is assigned the same reference numeral regardless of reference numeral, and a redundant description thereof is omitted.

Furthermore, in describing techniques disclosed in this specification, a detailed description of a related known technique will be omitted if it is deemed to make a subject matter disclosed in this specification vague. Furthermore, it is to be noted that the accompanying drawings are merely intended to aid in the understanding of the technical spirit disclosed in this specification and the technical spirit is not restricted by the accompanying drawings.

Hereinafter, a method of detecting a reception beam direction based on a hybrid reconfigurable intelligent surface (RIS) in a wireless communication system, which is proposed in this specification, is described in detail with reference to related drawings.

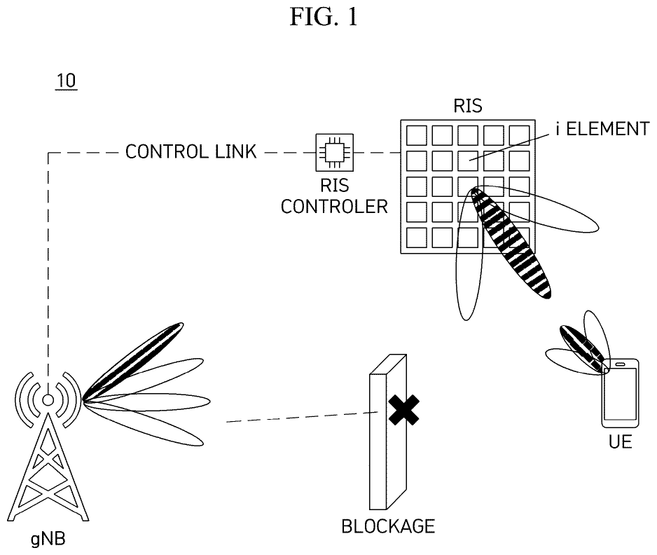

FIG. 1 illustrates an example of a concept view of an RIS support wireless communication system to which a method proposed in this specification may be applied.

In this specification, a transmitter may be called a transmission apparatus, a transmitting stage, a base station, or user equipment (UE). A receiver may be called a reception apparatus, a receiving stage, a base station, or UE.

Specifically, FIG. 1 illustrates a concept in which wireless communication is supported through a detour path based on a surrounding RIS when a signal does not reach a receiver (e.g., UE) because a direct path between transceivers is blocked due to a surrounding radio wave obstacle. In particular, in mobile communication system using a frequency band having a short wavelength, such as mm-wave or THz, communication interruption by a signal blocking phenomenon attributable to a radio wave obstruction is inevitable due to a severe path loss. In this case, as illustrated in FIG. 1, communication services may be provided to UE in a shadow area by forming a relay link through an RIS installed on a surface of a surrounding terrain. A signal received through the RIS is received through a beam including a beam pair by which (a base station transmission beam, an RIS reflection beam, and a UE reception beam) are configured to have an optimal channel state. In this case, the same beam pair may be applied to beamforming in a backward direction by applying channel reciprocity.

Referring to FIG. 1, a signal that is transmitted by a base station (e.g., gNB) is reflected by an n (n=1, . . . , N) reflection element of the RIS. When UE receives the signal reflected by the RIS, a cascade channel may be formed between the base station, the RIS, and the UE. In the case of the passive RIS, in order to determine the phase shift value of the n-th reflection element, a method of fixing the values of other elements except the n-th reflection element, determining a reflection element coefficient in a direction having a better channel state by adjusting the value of the n-th reflection element, and setting an optimal phase value of an RIS reflection surface by repeating the determination of the reflection element coefficient N times may be considered. However, the method requires estimation for all configurable phase shift values of the RIS reflection surface, and therefore, as the number of RIS reflection surface increases, the complexity grows exponentially. As an embodiment, when a practical wireless communication environment is considered, a method of determining a reflection beam which may be reflected in some specific directions with respect to a signal that is incident on the RIS and defining a set of phase shift values to be directed toward a specific direction as a codebook or a beam-book may be taken as an example. In this case, the phase shift vector of an RIS having a set of phase shift values that are reflected in a specific direction with respect to an m-th incident beam, that is, an m-th transmission beam, that is, an i-th codebook, may be defined like Equation 1.

$${θ}_{m , i} = {[ {Φ}_{1 , 1} {Φ}_{1 , 2} … ⋮ ⋮ ⋱ {Φ}_{m , 1} {Φ}_{m , 2} … {Φ}_{1 , i} ⋮ {Φ}_{m , i} ]}^{T} \qquad ( 1 )$$

In Equation 1, Φ_{m,i} may be defined as an RIS reflection element coefficient vector set that constitutes an m-th incident beam and an i-th reflection beam. As a method of selecting an optimal beam through the codebook, the quality 4 received signal for a set <an m-th transmission beam mode and an i-th reflection beam mode> may be measured. A signal quality value for each case may be stored. A beam set for the best case may be selected as an optimal beam. In this case, an index for measuring the signal quality may include RSRP, RSRQ, an SNR, and a BER.

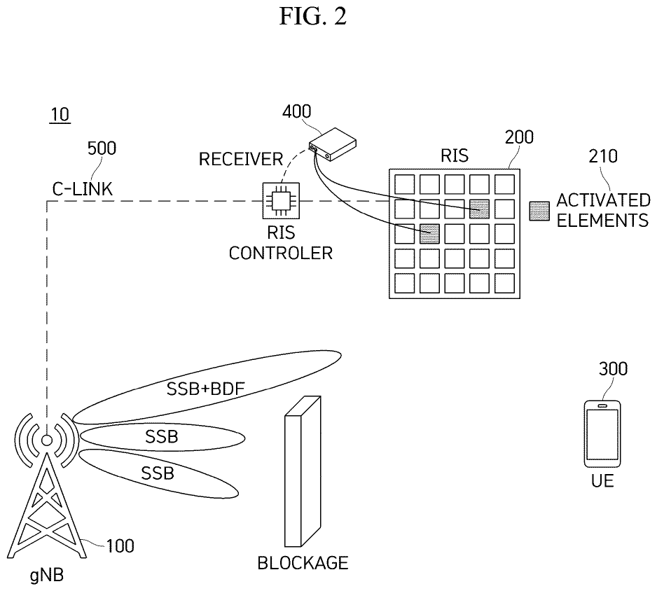

FIG. 2 is a diagram illustrating an example of a method of transmitting a beam direction finding-reference signal (BDF-RS) by using a synchronization signal block (SSB) in a wireless communication system based on a hybrid RIS, which is proposed in this specification.

That is, FIG. 2 illustrates an embodiment of a wireless communication system based on a hybrid RIS in which a receiver is configured in a very small number of reflection element of an RIS including a passive RIS 200. In FIG. 2, an element indicated by an activated element 210 may include a demodulation function, a timing function through a pilot, and a channel estimation function for a signal received through the RIS. Furthermore, a method of finding a beam direction that is proposed in this specification may be configured through a receiver 400 (or an RIS receiver) configured in the activated elements of the RIS.

In this specification, an optimal beam is a combination of a base station transmission beam, an RIS reflection beam, and a UE reception beam (a forward direction: base station->RIS->UE), and may be identically applied to a backward direction (UE->RIS->base station). Furthermore, in the method proposed in this specification, the configuration of the present disclosure is described on the basis of the 3GPP 5G NR standard, but the method proposed in this specification and an apparatus supporting the method may also be applied to another mobile communication standard.

By the configuration of the present disclosure, as illustrated in FIG. 2, a base station (or a transmitter) transmits a beam direction finding-reference signal (BDF-RS), that is, a reference signal for measuring a beam direction, along with a synchronization signal block (SSB) (or a transmission signal having a function similar to that of the SSB) including the synchronization signal of 5G NR with respect to an RIS direction transmission beam.

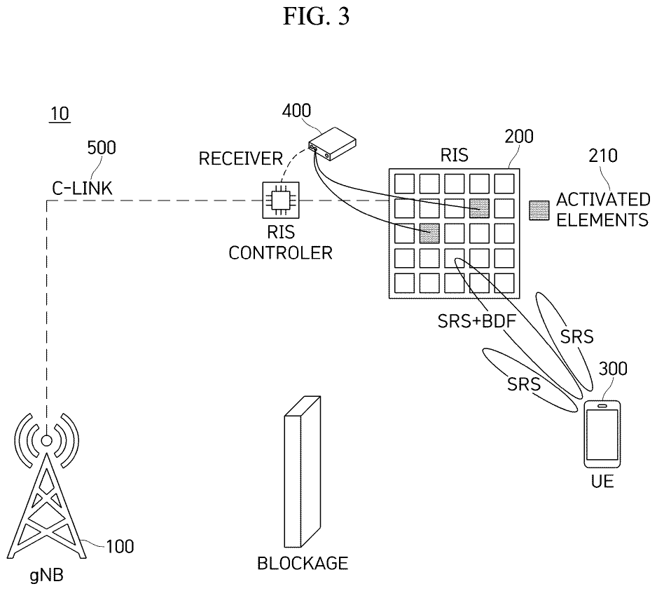

FIG. 3 illustrates an example of a method of transmitting a BDF-RS by using a sounding reference signal (SRS) in a wireless communication system based on a hybrid RIS, which is proposed in this specification.

As in FIG. 2, FIG. 3 is a method of transmitting, by UE, a reference signal for measuring a beam direction, and illustrates a concept in which a BDF-RS is transmitted along with an SRS with respect to an RIS direction transmission beam. In FIGS. 2 and 3, the RIS receiver 400 configured in the RIS includes a beam measuring instrument that receives the BDF-RS and finds a beam in a line-of-sight (LOS) direction, among received beams. A beam that is selected by the method may be reported to the base station through a C-link 500 that operates in conjunction with the beam management unit of an RIS controller in order to set the beam as an RIS reflection beam and that is for an interface between the RIS controller and the base station. This is merely an embodiment of the configuration of the present disclosure, and the present disclosure may be identically applied to another interface method between a base station and an RIS. The RIS controller may independently operate without being controlled by a network.

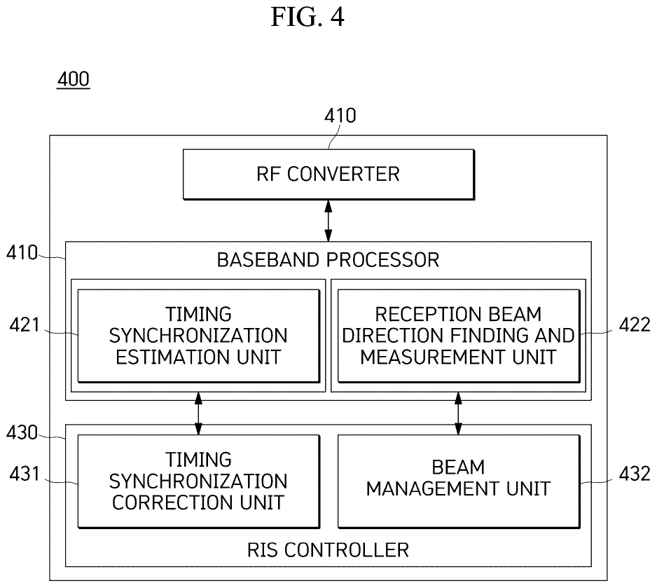

In FIGS. 2 and 3, the RIS receiver 400 that [0051] receives a signal through the activated elements of the RIS may include components illustrated in FIG. 4. FIG. 4 illustrates an example of an internal block diagram of an RIS receiver that is proposed in this specification.

Referring to FIG. 4, the RIS receiver 400 may include an RF converter (or an RF processor) 410, a baseband processor 420, and an RIS controller 430.

In this specification, the RIS receiver may be called an RIS apparatus, an RIS wireless apparatus, an RIS reception apparatus, or a relay apparatus.

The baseband processor and the RIS controller may be implemented as one module (or apparatus). In this case, the one module (or apparatus) may be simply called a processor, a controller, or a control unit.

The RF converter 410 converts an RF signal received through an antenna into a baseband signal through a mixer, a low noise amplifier (LNA), and an analog to digital converter (ADC). The baseband processor 420 may include a timing synchronization estimation unit 421 that estimates timing synchronization by receiving the synchronization signal of a radio signal and a reception beam direction finding and measurement unit 422 that measures a reception beam direction.

The timing synchronization estimation unit 421 of FIG. 4 performs a timing synchronization estimation function using a synchronization signal (e.g., an SSB) transmitted by the base station. In general, the RIS including the passive elements is configured along with a control circuit in order to set the coefficient of the RIS. The control circuit needs to perform a function that programs a reflection coefficient into an RIS reflection element at specific timing based on an RIS coefficient setting value and timing information. Accordingly, the passive RIS includes an RIS control circuit and may control the RIS through network control. The RIS controller that is proposed in this specification includes the function of the control circuit, and may perform an interface function with the base station through the C-link connected to the RIS controller through wired/wireless communication. RIS control by a wired communication method using an optical cable is high in the reliability of RIS control information transmitted as packet data, but has a disadvantage in that the accuracy of timing information in an actual radio transmission section is low. For example, as in a beam management method of 5G NR, in order to apply a method of transmitting a control signal for measuring an RIS beam in a specific slot and symbol and selecting a beam having the best RSRP and SNR through beam search and measurement, an accurate slot and symbol timing information are required. However, in RIS control based on wired communication, it is difficult to apply a beam management method that requires a specific time point. According to the method proposed in this specification, control information having high reliability may be transmitted through the C-link, timing information of a radio section may be obtained through a synchronization signal, and an RIS reflection coefficient may be set in slot unit and a symbol unit. As illustrated in FIG. 2, the RIS receiver that receives the SSB from the base station corrects slot timing by obtaining timing synchronization from the timing synchronization estimation unit 421 illustrated in FIG. 4 based on a primary synchronization signal (PSS) and secondary synchronization signal (SSS) of the SSB and transmitting the timing synchronization to the RIS controller.

A method of transmitting a BDF-RS and a method of measuring a beam by using the BDF-RS, which are proposed in this specification, are described more specifically.

In this specification, as an embodiment, an SSB and an SRS are described as an example, but the method proposed in this specification and an apparatus supporting the method may also be applied to a communication signal having a function similar to that of the SSB and the SRS. Furthermore, hereinafter, as an embodiment, a base station transmission beam, an RIS reflection beam, and a UE reception beam are basically described.

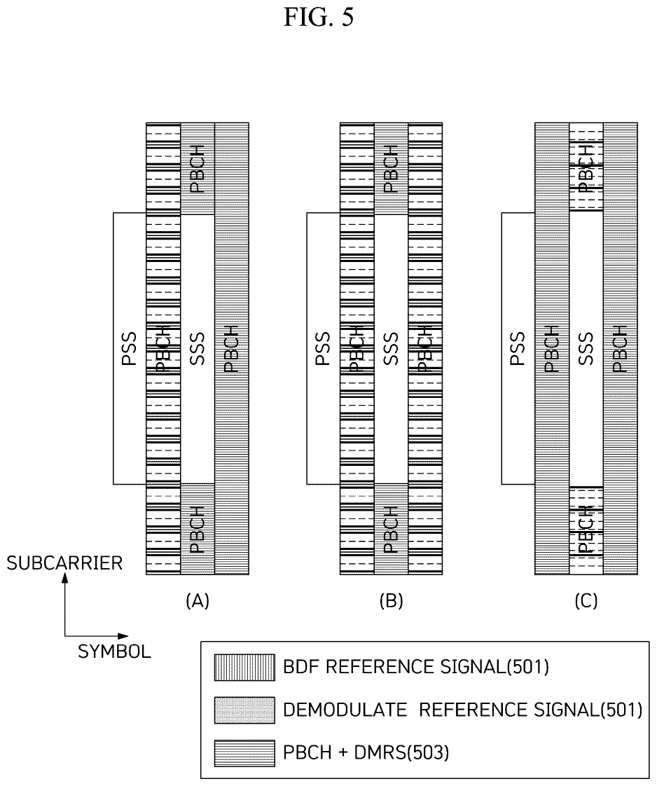

FIG. 5 is a diagram illustrating examples of a method of transmitting a beam direction finding-reference signal (BDF-RS), which is proposed in this specification.

In FIGS. 5A to 5C, a BDF-RS that is transmitted in order to measure a beam direction, which is proposed in this specification, may be configured in or allocated to a resource region of a physical broadcasting channel (PBCH) demodulation reference signal (DMRS) (PBCH DMRS) of an SSB. In FIG. 5, 501 denotes a BDF-RS that is transmitted in some regions of a PBCH DMRS. 502 and 503 denote a PBCH and/or DMRS of the 5G NR standard. In FIG. 5, the BDF-RS may be applied to an SSB that searches for an RIS direction beam when the base station transmits the SSB for beam search between the base station and the RIS in FIG. 2.

The BDF-RS that is proposed in this specification generates a digital beamforming signal having P precoding vectors as illustrated in Equation 2.

$${s}_{{k}^{′} , l , p}^{BDR - RS} = {s}_{{k}^{′} , l}^{DMRS} \cdot {w}_{p} , p = 1 , … , P \qquad ( 2 )$$

$${w}_{p} = \{ {\vec{α}}_{L , p} {k}^{′} ∈ A {\vec{α}}_{R , p} {k}^{′} ∈ B$$

$${k}^{′} = k , if ( k mod 12 ) = q + v$$

$$k = \{ 0 + v , 4 + v , 8 + v , … , 236 + v \} , when l = 1 , 3$$

In Equation 2,

$${s}_{{k}^{′} , l}^{DMRS}$$

is a pseudo-random sequence of the PBCH DMRS, and is generated by Equation 3.

$$r ( m ) = \frac{1}{\sqrt{2}} ( 1 - 2 c ( 2 m ) ) + j \frac{1}{\sqrt{2}} ( 1 - 2 c ( 2 m + 1 ) ) \qquad ( 3 )$$

In Equation 3, r(m) indicates

$${s}_{{k}^{′} , l}^{DMRS}$$

in Equation 2. In Equation 3, c(n) is defined as illustrated in Equation 4.

$$c ( n ) = ( {x}_{1} ( n + {N}_{c} ) + ( {x}_{2} ( n + {N}_{c} ) ) mod 2 , \qquad ( 4 )$$

$${x}_{1} ( n + 31 ) = ( {x}_{1} ( n + 3 ) + ( {x}_{1} ( n ) ) mod 2 ,$$

$${x}_{2} ( n + 31 ) = ( {x}_{2} ( n + 3 ) + {x}_{2} ( n + 2 ) + {x}_{2} ( n + 1 ) + {x}_{2} ( n ) ) mod 2$$

In Equation 4, N_{c}=1600. A first m-sequence x₁ (n) is initialized to x₁ (0)=1, x₁ (n)=0, n=1, 2, . . . , 30. A second m-sequence x₂ (n) is a value dependent on an application of a sequence and is defined as

$${c}_{init} = {\sum }_{i = 0}^{30} {x}_{2} ( i ) {2}^{i} .$$

In Equation 2,

$${s}_{{k}^{′} , l , p}^{BDR - RS}$$

is a BDF-RS, and is generated by multiplying a DMRS that belongs to a PBCH DMRS and that has an equal distance by a precoding weight wₚ according to the rule of Equation 2.

For example, as illustrated in FIG. 5A, if the BDF-RS is transmitted in l=1, that is, the second symbol of the SSB, when q=4 and v=0, a subcarrier on which the BDF-RS is transmitted may be k′={4, 16, 28, . . . , 232}. The precoding weight wₚ is a vector set of P antennas. In the present embodiment, the precoding weight wₚ indicates a weight value for forming a left beam and a right beam. The precoding weight corresponds to two digital beams each having the center shifted left and right at the same angle centering around a reference line, for example, a line-of-sight (LOS) line. As illustrated in Equation 5, the precoding weight is multiplied by a different weight depending on a reference signal that belongs to a subcarrier group A or a subcarrier group B. In this case, the subcarrier groups A and B do not overlap. A subcarrier for DMRS transmission or a subcarrier for BDF-RS transmission may be selected from the subcarrier group A or the subcarrier group B. The base station selects one direction in a transmission beam according to transmission beam sweeping and transmits the SSB and the BDF-RS.

$$BDFI ( Beam Dirction Finding Indicator ) = \frac{〈 {\vec{s}}^{DMRS} \cdot {\vec{s}}^{BFD - RS} 〉}{{‖ {\vec{s}}^{DMRS} ‖}^{2} {‖ {\vec{s}}^{BFD - RS} ‖}^{2}} , ∀ {k}^{′} \qquad ( 5 )$$

In Equation 5,

$${\vec{s}}^{DMRS}$$

indicates a vector for the sequence of the PBCH DMRS.

$${\vec{s}}^{BFD - RS}$$

indicates a vector for the sequence of the BDF-RS.

The BDF-RS generated by Equation 2 is demodulated based on symbol timing estimated by the timing synchronization estimation unit of the RIS receiver. Thereafter, the reception beam direction finding and measurement unit of FIG. 4 measures the direction of a transmission beam and transmits the beam ID and beam direction measurement value of a base station transmission beam to the RIS controller based on SSB index information. The reception beam direction finding and measurement unit may extract LOS direction information of the beam transmitted by the base station based on the internal value

$$〈 {\vec{s}}^{DMRS} \cdot {\vec{s}}^{BFD - RS} 〉$$

of two vectors in Equation 5.

The RIS controller of FIG. 4 may include a timing synchronization correction unit 431 and a beam management unit 432. The beam management unit 432 manages the BDFI of Equation 5 and SSB index information or beam ID information mapped to the SSB index information by mapping the BDFI and the SSB index information or the beam ID information. In this specification, as an embodiment, in order to reduce the amount of data information that is transmitted through the C-link, the beam management unit may apply a method of setting a BDFI threshold and filtering the data information based on a BDFI having the threshold or more. As described above, the method of finding a beam direction that is proposed in this specification may determine a value, which falls outside a reference line at a predetermined angle, to fall outside a LOS range. Accordingly, a beam having a BDFI exceeding the threshold may be set as a candidate beam that falls outside an interest angle, and may be subsequently reported to the base station when information on all of beams is required based on control.

A method of transmitting a BDF-RS in FIG. 5A has an advantage in that a comparison with a previously agreed reference signal is possible by obtaining accurate timing synchronization for the start of a symbol. The structure of FIG. 5B may be said to be less sensitive to timing synchronization because a reception beam direction can be measured through a comparison between signals that are received after a BDF-RS is transmitted on two symbols. The structure of FIG. 5C is a structure in which a reference signal is disposed in an upper band and lower band of an SSS transmission symbol. The configuration of the present disclosure is less sensitive to channel state information (CSI) regardless of the location of a band and may have the same arrangement as that of FIG. 5C because the configuration operates based on the estimation of a beam direction.

Furthermore, the method of configuring a BDF-RS in FIGS. 5A to 5C may also be applied to the SRS structure of UE. As an embodiment of this configuration, the RIS receiver and the UE may obtain timing synchronization through an SSB signal transmitted by the base station. As described with reference to FIG. 1, when the UE does not receive a radio wave on a direct path due to a surrounding obstacle or the base station configures a detour path in the UE through an RIS that is installed nearby, the RIS may switch from a reception mode to a reflection mode through control of the base station. The RIS may relay a signal transmitted by the UE through a beam that is basically configured. When obtaining the cell ID and timing synchronization of the base station, the UE may select the structure of FIGS. 5A to 5C and configure the SRS and the BDF-RS.

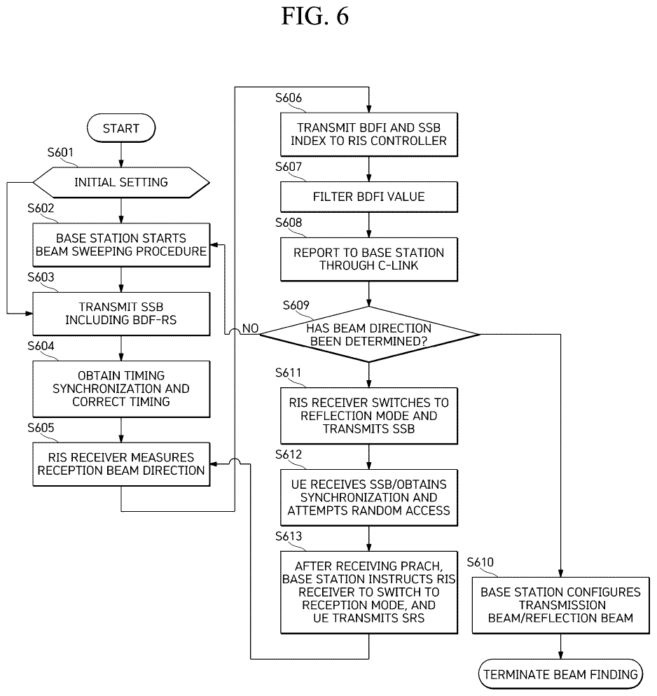

FIG. 6 is a flowchart illustrating an example of a method of finding a beam direction, which is proposed in this specification.

More specifically, FIG. 6 illustrates a flowchart of a method of finding a beam direction, for managing a base station transmission beam, an RIS reflection beam, and a UE reception beam.

In a base station initial-setting information step S601, the base station may be provided with information on the location of an RIS or installation information of an apparatus having a function similar to that of the RIS in a wired and/or wireless manner through the RIS controller. Furthermore, the base station starts a beam sweeping procedure S602 through a beam search procedure. As an embodiment, in step S601, when the base station can estimate an RIS direction beam based on RIS installation information, the base station transmits a BDF-RS along with an SSB with respect to an RIS direction beam (S603). However, the base station may transmit the BDF-RS along with the SSB with respect to all of beams according to a common beam sweeping method. In this case, the RIS receiver obtains timing synchronization through the timing synchronization estimation unit of FIG. 4 and corrects slot and symbol timing (S604). In step S601, an initial operation of the RIS receiver is set in the reception mode. After the timing is adjusted in step S604, the RIS receiver measures a reception beam direction (S605) by calculating a BDFI according to Equation 5 through the reception beam direction finding and measurement unit by using the BDF-RS received in step S603. Furthermore, the RIS receiver transmits the calculated BDFI and an SSB index detected based on the result of PBCH demodulation to the RIS controller (S606). The RIS controller may filter a BDFI value (S607) on the basis of a threshold that is set to limit a transmission beam of the base station to a LOS direction beam, and may report the result of the measurement of the base station transmission beam to the base station through the C-link with respect to base station transmission beams each having the threshold or more (S608). However, if the results of the BDFIs of two or more beams are similar in steps S607 and S608, the RIS controller may report all of the results to the base station so that the base station determines a transmission beam. That is, the base station performs a determination procedure (S609) of determining a base station transmission beam. When the base station transmission beam is determined in step S609, the base station configures the base station transmission beam and an RIS reflection beam (S610), and terminates the beam search. In this case, when determining the base station transmission beam, the base station may instruct the RIS receiver to switch to the reflection mode (S611), and may transmit an SSB. The UE obtains timing synchronization by receiving the SSB and attempts random access to the base station through the RIS (S612). When the base station fails in the determination of the base station transmission beam in step S609, the base station performs the process again from step S602. When receiving a PRACH transmitted by the UE in step S612, the base station performs a procedure of transmitting a message Msg 3 to the UE, and instructs the RIS receiver to switch to the reception mode through the C-link. The UE that has received the message Msg3 from the base station transmits an SRS and a BDF-RS (S613).

Thereafter, the RIS receiver repeats steps S605 to S608. The base station determines the direction of an RIS reception beam in step S609, determines the direction of the RIS reflection beam to be a reception beam direction, transmit reflection beam configuration information to the RIS receiver, and terminates the beam search.

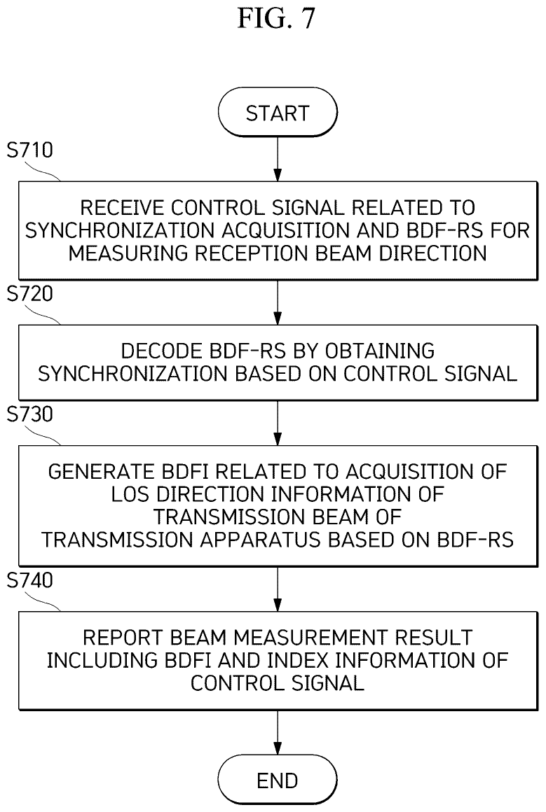

FIG. 7 is a flowchart illustrating an example of a method of finding a beam direction by using a hybrid RIS in a wireless communication system, which is proposed in this specification.

First, the RIS apparatus receives a control signal related to synchronization acquisition and a beam direction finding-reference signal (BDF-RS) that is used to measure a reception beam direction from a transmission apparatus (S710).

Step S710 may be performed in the reception mode of the RIS apparatus.

The control signal may be a synchronization signal block (SSB). In this case, the transmission apparatus may be a base station.

When the control signal is an SSB, the BDF-RS may be transmitted in at least one of a PBCH resource region of the SSB or a DMRS resource region for PBCH transmission. The sequence of the BDF-RS may be generated by multiplying the sequence of a DMRS by a precoding weight value set as a vector set of a plurality of antennas.

In this case, the value of the precoding weight may include two values of beams each having the center shifted left and right at the same angle centering around a LOS direction. A different value of the precoding weight may be applied to the sequence of the DMRS for each subcarrier group.

Alternatively, the control signal may be a sounding reference signal (SRS). In this case, the transmission apparatus may be UE.

Furthermore, the RIS apparatus decodes the BDF-RS by obtaining synchronization based on the control signal (S720).

Furthermore, the RIS apparatus generates a beam direction finding indicator (BDFI) related to the acquisition of line-of-sight (LOS) direction information of a transmission beam of the transmission apparatus based on the decoded BDF-RS (S730).

Furthermore, the RIS apparatus reports a beam measurement result, including the BDFI and index information of the control signal, to the transmission apparatus (S740).

After step S730, the RIS apparatus may compare the BDFI with a threshold that is preset to limit the transmission beam to a LOS direction beam.

In this case, in step S740, the BDFI included in the result of the measurement of the beam may be a BDFI having a value equal to or greater than the threshold.

When the control signal is an SSB, the BDFI may be generated as an internal value of a vector for the sequence of the DMRS for PBCH transmission and a vector for the sequence of the BDF-RS.

After step S740, the RIS apparatus may further perform a step of receiving instruction information to switch from the reception mode to the reflection mode from the transmission apparatus and switching from the reception mode to the reflection mode based on the instruction information.

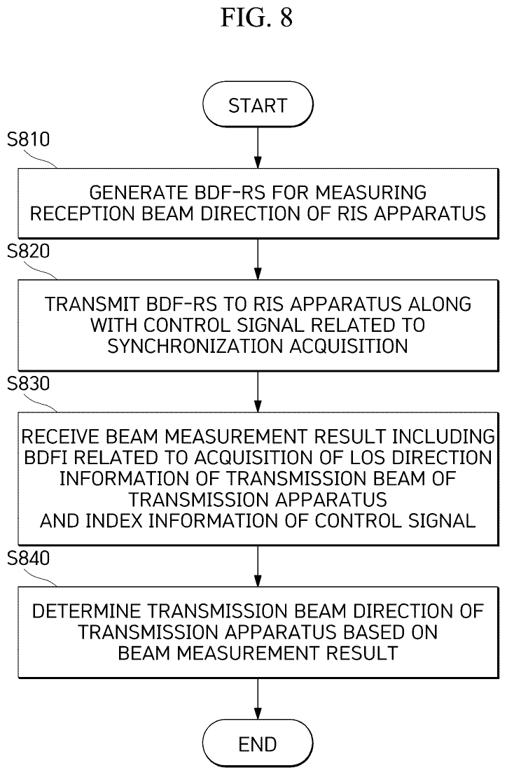

FIG. 8 is a flowchart illustrating another example of a method of finding a beam direction by using a hybrid RIS in a wireless communication system, which is proposed in this specification.

A transmission apparatus generates a BDF-RS that is used to measure a reception beam direction of the RIS apparatus (S810).

Furthermore, the transmission apparatus transmits the BDF-RS to the RIS apparatus along with a control signal related to synchronization acquisition (S820).

Furthermore, the transmission apparatus receives a beam measurement result, including a beam direction finding indicator (BDFI) related to the acquisition of line-of-sight (LOS) direction information of a transmission beam of the transmission apparatus and index information of the control signal, from the RIS apparatus (S830).

Furthermore, the transmission apparatus determines the transmission beam direction of the transmission apparatus based on the beam measurement result (S840).

The BDFI may have a value equal to or greater than a threshold that is preset to limit the transmission beam to a LOS direction beam.

The control signal may be a synchronization signal block (SSB) or a sounding reference signal (SRS).

When the control signal is an SSB, the BDF-RS may be transmitted in at least one of a PBCH resource region of the SSB or a DMRS resource region for PBCH transmission. The sequence of the BDF-RS may be generated by multiplying the sequence of a DMRS by a precoding weight value set as a vector set of a plurality of antennas. The BDFI may be generated as an internal value of a vector for the sequence of the DMRS for PBCH transmission and a vector for the sequence of the BDF-RS.

In the aforementioned embodiments, the components and characteristics of the present disclosure have been combined in a specific form. Each of the components or characteristics may be considered to be optional unless otherwise described explicitly. Each of the components or characteristics may be implemented in a form not to be combined with other components or characteristics. Furthermore, some of the components or the characteristics may be combined to form an embodiment of the present disclosure. The sequence of the operations described in the embodiments of the present disclosure may be changed. Some of the components or characteristics of an embodiment may be included in another embodiment or may be replaced with corresponding components or characteristics of another embodiment. It is evident that an embodiment may be constructed by combining claims not having an explicit citation relation in the claims or may be included as a new claim by amendments after filing an application.

The embodiment according to the present disclosure may be implemented by various means, for example, hardware, firmware, software or a combination of them. In the case of an implementation by hardware, the embodiment of the present disclosure may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the present disclosure may be implemented in the form of a module, procedure or function for performing the aforementioned functions or operations. Software code may be stored in the memory and driven by the processor. The memory may be located inside or outside the processor and may exchange data with the processor through a variety of known means,

It is evident to those skilled in the art that the present disclosure may be embodied in other specific forms without departing from the essential characteristics of the present disclosure. Accordingly, the detailed description should not be construed as being limitative from all aspects, but should be construed as being illustrative. The scope of the present disclosure should be determined by reasonable analysis of the attached claims, and all changes within the equivalent range of the present disclosure are included in the scope of the present disclosure.

What is claimed is:

1. A method of finding a beam direction by using a hybrid reconfigurable intelligent surface (RIS) in a wireless communication system, the method performed in an RIS apparatus comprising:
receiving a control signal related to synchronization acquisition and a beam direction finding-reference signal (BDF-RS) that is used to measure a reception beam direction from a transmission apparatus;
decoding the BDF-RS by obtaining synchronization based on the control signal;
generating a beam direction finding indicator (BDFI) related to an acquisition of line-of-sight (LOS) direction information of a transmission beam of the transmission apparatus based on the decoded BDF-RS; and
reporting a beam measurement result comprising the BDFI and index information of the control signal to the transmission apparatus.

2. The method of claim 1, wherein the control signal is a synchronization signal block (SSB).

3. The method of claim 1, wherein the control signal is a sounding reference signal (SRS).

4. The method of claim 1, further comprising comparing the BDFI with a threshold that is preset to limit the transmission beam to a LOS direction beam.

5. The method of claim 4, wherein the BDFI included in the beam measurement result is a BDFI having a value equal to or greater than the threshold.

6. The method of claim 2, wherein the BDF-RS is transmitted in at least one of a PBCH resource region of the SSB or a demodulation reference signal (DMRS) resource region for PBCH transmission.

7. The method of claim 6, wherein a sequence of the BDF-RS is generated by multiplying a sequence of the DMRS by a value of a precoding weight including a vector set of a plurality of antennas.

8. The method of claim 7, wherein the value of the precoding weight comprises two values of beams each having a center shifted left and right at an identical angle centering around the LOS direction.

9. The method of claim 8, wherein a different weight value is applied to the sequence of the DMRS for each subcarrier group.

10. The method of claim 6, wherein the BDF-RS is allocated to at least one symbol at which the PBCH is allocated to the SSB or allocated to an upper band and lower band of a frequency band to which a secondary synchronization signal (SSS) of the SSB is allocated.

11. The method of claim 2, wherein the BDFI is generated as an internal value of a vector for a sequence of the DMRS for PBCH transmission and a vector for a sequence of the BDF-RS.

12. The method of claim 1, wherein the RIS apparatus receives the control signal and the BDF-RS in a reception mode.

13. The method of claim 12, further comprising:
receiving instruction information that instructs the RIS apparatus to switch from the reception mode to a reflection mode from the transmission apparatus; and
switching, by the RIS apparatus, from the reception mode to the reflection mode based on the instruction information.

14. A method of finding a beam direction by using a hybrid reconfigurable intelligent surface (RIS) in a wireless communication system, the method performed in a transmission apparatus comprising:
generating a beam direction finding-reference signal (BDF-RS) that is used to measure a reception beam direction of an RIS apparatus;
transmitting the BDF-RS to the RIS apparatus along with a control signal related to synchronization acquisition;
receiving a beam measurement result comprising a beam direction finding indicator (BDFI) related to an acquisition of line-of-sight (LOS) direction information of a transmission beam of the transmission apparatus and index information of the control signal from the RIS apparatus; and
determining a transmission beam direction of the transmission apparatus based on the beam measurement result.

15. The method of claim 14, wherein the BDFI has a value equal to or greater than a threshold that is preset to limit the transmission beam to an LOS direction beam.

16. The method of claim 14, wherein the control signal is a synchronization signal block (SSB).

17. The method of claim 16, wherein the BDF-RS is transmitted in at least one of a PBCH resource region of the SSB or a DMRS resource region for PBCH transmission.

18. The method of claim 17, wherein a sequence of the BDF-RS is generated by multiplying a value of a precoding weight comprising a vector set of a plurality of antennas by a sequence of the DMRS.

19. The method of claim 14, wherein the BDFI is generated as an internal value of a vector for a sequence of the DMRS for PBCH transmission and a vector for a sequence of the BDF-RS.

20. A reconfigurable intelligent surface (RIS) apparatus for finding a beam direction by using a hybrid RIS in a wireless communication system, the RIS apparatus comprising:
an RF processing module configured to convert an RF signal received through an antenna into a baseband signal;
a baseband processing module configured to decode a beam direction finding-reference signal (BDF-RS) by obtaining timing synchronization based on a control signal related to synchronization acquisition and configured to generate a beam direction finding indicator (BDFI) related to an acquisition of line-of-sight (LOS) direction information of a transmission beam of a transmission apparatus based on the BDF-RS; and
an RIS processor configured to manage the BDFI and index information of the control signal by mapping the BDFI and the index information and configured to compare the BDFI with a threshold that is preset to limit the transmission beam to a LOS direction beam.
